(19) United States
(12) Patent Application Publication
(10) Pub. No.: US 2025/0286071 A1
(43) Pub. Date: Sep. 11, 2025

(54) High-Energy Lithium Metal Batteries Enabling Extremely Fast Charge and Discharge

(71) Applicant: BOARD OF TRUSTEES OF THE UNIVERSITY OF ARKANSAS, Little Rock, AR (US)

(72) Inventor: Xiangbo Meng, Fayetteville, AR (US)

(73) Assignee: BOARD OF TRUSTEES OF THE UNIVERSITY OF ARKANSAS, Little Rock, AR (US)

(21) Appl. No.: 18/861,146

(22) PCT Filed: Apr. 27, 2023
(86) PCT No.: PCT/US2023/020250

§ 371 Date: Oct. 28, 2024

Related U.S. Application Data
(60) Provisional application No. 63/335,503, filed on Apr. 27, 2022.

(51) Int. Cl. H01M 4/62; H01M 4/02; H01M 4/04; H01M 4/131; H01M 4/134; H01M 4/38; H01M 4/525; H01M 10/052

(52) U.S. Cl. CPC H01M 4/628; H01M 4/0428; H01M 4/131; H01M 4/134; H01M 4/382; H01M 4/525; H01M 10/052; H01M 2004/027; H01M 2004/028

(57) ABSTRACT

The e present invention concern methods, devices, and systems that create a stable interface for accomplishing commercial Li|INMC811 LMBs. In other aspects of the invention, the coatings via atomic or/and molecular layer deposition (A/MLD or A-MLD) are conformal and uniform. They can be coated on both NMC cathodes and Li anodes directly with accurate growth control at the atomic/molecular level. In other embodiments. the MLD LiGL (GL=glycerol) and LiTEA (TEA triethanolamine) coatings of the present invention have clearly demonstrated significant effects on improving the performance of LHNMC811 cells up to 400%. in terms of sustainable capacity of NMC811.

### RELATED APPLICATIONS

This application is a U.S. 371 National Phase of PCT/US2023/020250 filed on Apr. 27, 2023, which claims priority to U.S. Provisional Application No. 63/335,503, filed on Apr. 27, 2022, both of which are incorporated herein in their entirety.

### STATEMENT REGARDING FEDERALLY SPONSORED RESEARCH & DEVELOPMENT

This invention was made with government support by the NSF grant OIA-1457888. The government has certain rights in the invention.

### BACKGROUND OF THE INVENTION

Transportation electrification represents a spectacular “green” solution to the aggravating depletion of fossil fuels, given the fact that currently transportation consumes around 30% of the total energy in the United States. It will also remarkably reduce pollution from combustion of fossil fuels. To this end, a desirable battery technology is needed to meet multiple requirements for powering electric vehicles (EVs): an energy density of ≥300 Wh/kg at cell level, a driving range of ≥300 miles per charge, an affordable cost of ≤$125/kWh, reliable safety free of fires and explosions, and long lifetime of ≥15 calendar years. Lithium-ion batteries (LIBs) are the best commercialized battery technology to date, but are still unsatisfactory for powering EVs: (i) limited energy density (<250 Wh/kg at cell level), high cost ($156/kWh), unreliable safety (fires and explosions), and deficient lifetime (<10 years). Therefore, better batteries are urgently needed.

In searching for an alternative technology, Li∥NMC lithium metal batteries (LMBs) have stood out, in which lithium (Li) metal and layer-structured lithium nickel manganese cobalt oxides (LiNiₓMn_{y}Co_{z}O₂, NMCs, x+y+z=1) are adopted as the anode and cathode, respectively. Li metal has the highest theoretical capacity of 3860 mAh/g at room temperature (RT), more than 10 times higher that of the current graphite anodes (372 mAh/g) in LIBs. Moreover, Li metal has the lowest negative electrochemical potential (−3.04 V versus the standard hydrogen electrode).

With varying Ni—Mn—Co compositions, NMCs can be LiNi_{1/3}Mn_{1/3}Co_{1/3}O₂ (NMC111), LiNi_{0.4}Mn_{0.4}Co_{0.2}O₂ (NMC442), LiNi_{0.5}Mn_{0.3}Co_{0.2}O₂ (NMC532), LiNi_{0.6}Mn_{0.2}Co_{0.2}O₂ (NMC622), LiNi_{0.8}Mn_{0.1}Co_{0.1}O₂ (NMC811), and even higher Ni contents. In these NMCs, the transition metal ions play their specific roles: Ni ions contribute to the majority of capacity through the Ni₂₊/Ni³⁺ and Ni³⁺/Ni₄₊ redox couples; Co ions suppress Ni/Li cationic mixing in the synthesis and cycling while increasing rate capability; and Mn ions stabilize the structure and enhance thermal stability by remaining +4 valence to act as a structural stabilizer. With an increased Ni content, the resulting NMC cathode enables a higher capacity and lower weight. To date, NMCs with Ni ≤0.6 have been commercialized, while it is particularly challenging to commercialize NMC811 or the ones with higher Ni contents. Compared to a capacity of ˜180 mAh/g of NMC622 (charged to 4.3 V), NMC811 can enable much higher capacities from 215 mAh/g (charged to 4.2 V) to 260 mAh/g (charged to 4.7 V). At the same time, the cost of NMC811 will be significantly decreased owing to the reduction in the expensive Co element.

Coupling NMC811 with Li anodes, as a result, Li∥NMC811 batteries theoretically enable an energy density up to 800 Wh/kg at the materials level, 2 times higher than that of the currently commercialized LiCoO₂ (LCO)∥graphite LIBs. On the cell level (considering liquid electrolytes, current collectors, and packaging materials), these benefits promise Li∥NMC LMBs an energy density of 400-600 Wh/kg, making them an ideal power supply for EVs.

However, both Li anodes and NMC cathodes suffer several challenges (see FIG. 1). The issues of Li anodes lie in two main aspects: (i) continuous formation of non-uniform and unstable solid electrolyte interphase (SEI) and (ii) Li dendritic growth. Li metal is highly reactive to organic liquid electrolytes (oLEs), leading to the formation of an SEI layer on its surface. The SEI layer is ionically conducting but electrically insulating. In addition, the SEI layer is also mechanically fragile and mosaic in composition. During Li plating, the huge volume expansion of Li anodes can rupture the fragile and mosaic SEI layer, promoting a preferential Li deposition through the cracks with the production of Li dendrite growth. During Li stripping, volume contraction further fractures the SEI layer, while stripping from kinks in a dendrite or from its roots can break the electrical contact and produce “dead” Li that is electrically isolated from the substrate. After continuous Li plating/stripping cycles, the repeated processes can produce a porous Li anode consisting of a thick accumulated SEI layer and excessive dead Li, leading to blocked ion transport and capacity fading. In addition, Li dendrites can potentially penetrate the separator and lead to internal short circuits, posing serious safety hazards.

NMC powders generally are micron-sized spherical polycrystalline particles (secondary particles) consisting of nanosized single crystals (primary particles). All NMCs have similar differential capacity-voltage ((dQ/dV)−V) profiles. During a charge process, NMCs experience multiple phase transitions from hexagonal (H1) to monoclinic (M) and hexagonal (H2 and H3) phases, while these phases are reversed during the subsequent discharge process. With the increasing Ni content, the voltage for the H2→H3 phase transition decreases, which is >4.6 V for NMC622, NMC532, and NMC111, but is ˜4.3 for NMC811. Compared to NMCs with x≤0.6, NMC811 suffers from the following issues: (i) oxygen release, (ii) Ni/Li cationic mixing, (iii) the irreversible layered-spinel-rocksalt phase transition, (iv) transition metal ion dissolution, (v) microcracking, and (vi) safety hazards. First, oxygen can be released from NMCs near the onset of H2→H3 phase transition, i.e., ˜70-80% state-of-charge (SOC). The released oxygen can oxidize oLEs with gas generation. It is a key cause for the depletion of oLEs, cathode degradation, and safety hazards. Among the three metal ions (M²⁺, i.e., Ni²⁺, Co²⁺, and Mn²⁺), second, Ni²⁺ ions (0.69 Å) have similar ionic radius as that of Li⁺ ions (0.76 Å) and are prone to mix with Li⁺ ions partially. This mixing reduces Li⁺ mobility and the capacity of NMCs, and leads to the transformation of the crystal structure from layered over spinel to NiO-like rock salt phase. The mixing degree increases with the Ni content, SOC, and operational temperature. Third, this layered-spinel-rocksalt transition is an inevitable result of Ni/Li mixing and oxygen release. Oxygen release in the bulk NMCs is kinetically hindered, due to long oxygen diffusion paths. However, the layered-spinel-rock salt phase transition is much more severe near the surface of NMC particles and of cracks than in the bulk of cathode particles. Since the NiO-like rock salt phase and the decomposition products of oLEs are neither electrochemically active nor ionically conductive, their accumulation results in the formation of a thick and highly resistive surface layer, which consequently increases the battery's impedance. To make the situation worse, the layered-spinel-rock salt phase transition aggravates with SOC and cycling number, and eventually the characteristics for the H2→H3 phase transition disappears, resulting in the declines of capacity and voltage. Fourth, released oxygen can react with oLEs to produce H₂O. H₂O can further react with LiPF₄ to produce some HF. Then, HF reacts with MO to form soluble MF₂ and H₂O. Thus, this is a self-accelerating process driven by the Ni/Li mixing and oxygen release. Fifth, oxygen release and the irreversible layered-spinel-rocksalt phase transition generates a large strain during charging process, which leads to the dramatic shrinkage of lattice unit cell volume in H2→H3. Consequently, there are intragranular cracks developed in primary particles, and intergranular cracks developed in secondary particles during charge/discharge processes. oLEs can penetrate these microcracks and react with released oxygen. These reactions can accelerate gas generation and impedance growth, leading to a decline in battery capacity and working voltage. In addition, microcracking can lead to the detachment of NMC active materials from the electrodes. This further leads to reduced electronic conductivity and loss of effective active particles. Furthermore, a charge cutoff voltage higher than 4.5 V (all voltages in this proposal are against Li/Li⁺) can help approach the theoretical capacity, but aggravates the structural, interfacial, and thermodynamic instabilities of NMC811. In the H3 phase, the last but not the least, the delithiated cathodes are very thermodynamically unstable. They can either chemically oxidize oLEs or spontaneously release oxygen. The dissolved oxygen may crossover through the separator, reach the anode, and chemically react with the lithiated anode (e.g., graphite in LIBs). Such a reaction is far more energetic than the reaction with electrolyte solvents and may lead to thermal runaway of LIBs. Thus, stabilizing the H3 phase is the key to increase the safety of NMC cathodes. In addition, the electrochemical reduction of the dissolved transition metal ions (M²⁺) and the generated CO₂ on the anode irreversibly consumes Li+ ions from the cathode, which consequently reduces the cathode/anode capacity ratio. As such, the cathode could get overcharged, triggering safety issues (e.g., fire accidents) even when a battery is charged in the normal voltage range.

Apparently, the issues of both Li anodes and NMC cathodes are highly related to their interface instability. It is critical to constitute a robust stable interface for Li metal and NMC811 to achieve their high performance. However, the progress to date is insufficient and more efforts are needed for commercialization of Li∥NMC811 LMBs.

### BRIEF SUMMARY OF THE INVENTION

In one embodiment, the present invention concern methods, devices, and systems that create a stable interface for accomplishing commercial Li∥NMC811 LMBs.

In other aspects of the invention, the coatings via atomic or/and molecular layer deposition (A/MLD or A-MLD) are conformal and uniform. They can be coated on both NMC cathodes and Li anodes directly with accurate growth control at the atomic/molecular level.

In other embodiments, the MLD LiGL (GL=glycerol) and LiTEA (TEA=triethanolamine) coatings of the present invention have clearly demonstrated significant effects on improving the performance of Li∥NMC811 cells up to 400%, in terms of sustainable capacity of NMC811 (see FIGS. 3-8). The beneficial effects lie in multiple aspects including mitigation of SEI formation and inhibit Li dendrites from growth. The beneficial effects of the MLD LiGL and LiTEA coatings may also include mitigating the negative effects due to the dissolved transition metal ions of NMC811, facilitating the transport of Li ions, and reducing the consumption of the electrolyte.

In other embodiments, the ALD Li₂S and ZrS₂ coatings of the present invention have clearly demonstrated significant effects on improving the performance of Li∥NMC811 cells up to 300%, in terms of sustainable capacity of NMC811 (see FIG. 8). The beneficial effects lie in multiple aspects including scavenging released oxygen from NMC811, protecting electrolytes from oxidation, mitigating microcracking, inhibiting irreversible phase transition, reducing metal dissolution, and suppressing Ni/Li cationic mixing.

In other embodiments, both the MLD coatings (LiGL and LiTEA) and the ALD coatings (Li₂S and ZrS₂) of the present invention together have clearly demonstrated significant effects on improving the performance of Li∥NMC811 cells up to 300%, in terms of sustainable capacity of NMC811 (see FIGS. 5-8). The MLD coatings on Li anodes and the ALD coatings on NMC811 cathodes together greatly extended the lifetime of Li∥NMC811 cells for at least 200%. The beneficial effects lie in multiple aspects including the merits of these MLD coatings on Li anodes and the benefits of these ALD coatings on NMC811.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 illustrates issues with Li∥NMC LMBs having their roots in Li metal anodes and NMC cathodes.

FIG. 2 shows surface modified Li∥NMC LMBs with coatings over Li metal anodes and NMC cathodes via A/MLD or A-MLD.

FIG. 3 shows the rate capability of LiGL250-Li∥NMC811 and Li∥NMC811under different current rates (1 C=150 mA/g) in the voltage range of 2.0-4.1 V, showing that the LiGL coating of 250 MLD cycles (i.e., LiGL250) on Li metal (i.e., LiGL250-Li) is remarkably beneficial to improve sustainable capacity of LiGL250-Li∥NMC811 cells under different current rates. The electrolyte is 1 M LiTFSI (lithium bis(trifluoromethanesulfonyl)imide) in 1:1 DOL/DME (DOL=1,3-dioxolane and DME=1,2-dimethoxyethane).

FIG. 4 shows the cyclability of LiGL250-Li∥NMC811 and Li∥NMC811 at 2 C (1 C=150 mA/g) in the voltage range of 2.0-4.1 V, showing that the LiGL coating of 250 MLD cycles on Li metal (i.e., LiGL250-Li) is remarkably beneficial to improve the sustainable capacity and cyclability of LiGL250-Li∥NMC811 cells. The electrolyte is 1 M LiTFSI in 1:1 DOL/DME.

FIG. 5 shows the cyclability of LiGL200-Li∥NMC811, LiGL200-Li|Li₂S20-NMC811, and Li∥NMC811 at 4 C (1C=150 mA/g) in the voltage range of 2.0-4.1 V, showing that the LiGL coating of 200 MLD cycles on Li metal (i.e., LiGL200-Li) and the Li₂S coating of 20 ALD cycles on NMC811 (e.g., Li₂S20-NMC811) are remarkably beneficial to improve the sustainable capacity of LiGL200-Li∥NMC811 and LiGL200-Li∥Li₂S20-NMC811 cells. The electrolyte is 1 M LiTFSI in 1:1 DOL/DME.

FIG. 6 shows the cyclability of LiGL100-Li∥NMC811, LiGL200-Li∥NMC811, LiGL300-Li∥NMC811, and Li∥NMC811 at 5 C (1 C=200 mA/g) in the voltage range of 2.0-4.3 V, showing that the MLD LiGL coatings of 100, 200, and 300 cycles is remarkably beneficial to improve sustainable capacity of LiGL100-Li∥NMC811, LiGL200-Li∥NMC811, and LiGL300|NMC811 cells, respectively. The electrolyte is 1 M LiTFSI in 1:1 DOL/DME.

FIGS. 7A and 7B show the cyclability of Li∥NMC811 and LiGL200-Li∥NMC811 at 1 C (1 C=200 mA/g) in the voltage range of 3.0-4.3 V, showing that (a, b) the LiGL coating of 200 MLD cycles is remarkably beneficial to improve sustainable capacity of LiGL200-Li∥NMC811 cell. The electrolyte is 1.2 M LiPF₆ in 3:7 EC/EMC (EC=ethylene carbonate and EMC=ethyl methyl carbonate).

FIGS. 8A, 8B and 8C show the effects of MLD coatings of LiGL and LiTEA and the ALD coatings of Li₂S and ZrS₂ on the performance of Li∥NMC811 cells, where the MLD coatings were deposited on Li anodes and the ALD coatings were deposited on NMC811 cathodes. (a) LiGL200-Li∥Li₂S20-NMC811 has the best performance while both LiGL200-Li∥NMC811 and Li∥Li₂S20-NMC811 cells performed better than Li∥NMC811. (b) LiGL200-Li∥ZrS₂20-NMC811 has the best performance while both LiGL200-Li∥NMC811 and Li∥ZrS₂20-NMC811 cells performed better than Li∥NMC811. (c) LITEA200-Li∥Li₂S20-NMC811 has the best performance while the LiTEA200-Li∥NMC811 cell performed better than Li∥NMC811. All the cells tested first for 2 charge-discharge cycles at 0.2 C and then tested in the following cycles at 1 C (1 C=200 mA/g) in the voltage range of 3.0-4.3 V. the results show that the ALD and MLD coatings have remarkable benefits on Li∥NMC811 cells and the Li∥NMC811 could achieve the best performance with both an MLD-coated Li anode and an ALD-coated cathode. The electrolyte is 1.2 M LiPF6 in 3:7 EC/EMC.

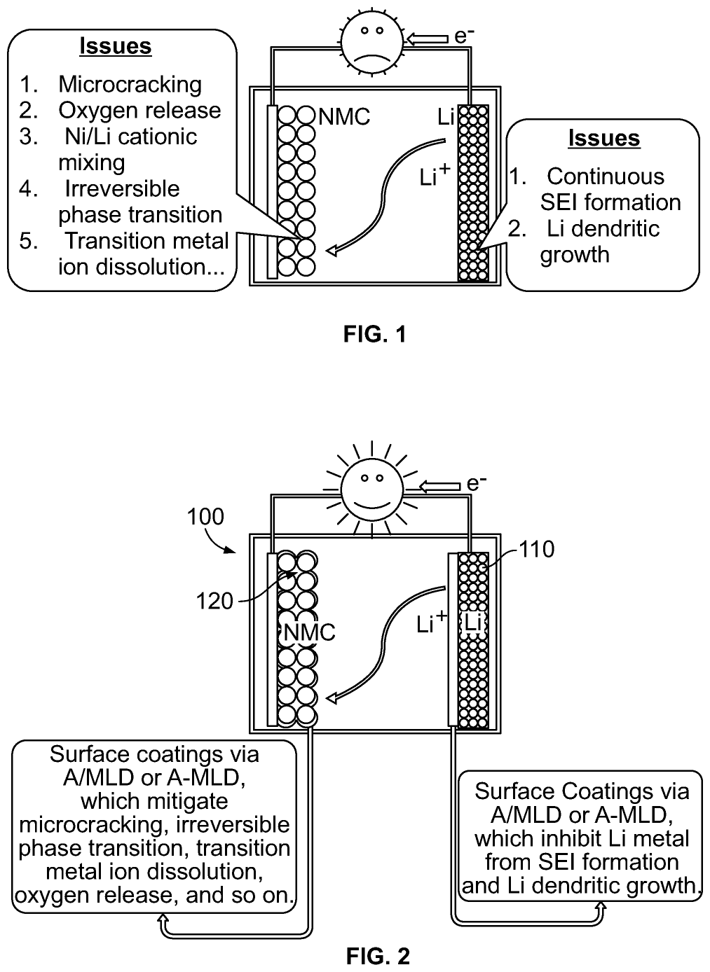

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

As shown in FIG. 2, in a preferred embodiment, the present invention provides a battery 100 having surface-modified Li anodes 110 and NMC811 cathodes 120 that can be coupled to constitute high-energy Li∥NMC811 LMBs enabling extremely fast charge and discharge up to 5 C, where 1 C means one charge or discharge (charge/discharge) in one hour while 5 C means one charge/discharge in ⅕ hours (12 min per charge/discharge). The surface modification of Li anodes and NMC811 cathodes in this invention is fulfilled via atomic or/and molecular layer deposition (A/MLD or A-MLD). The surface coatings can be inorganic (e.g., oxides and sulfides) via ALD, or organic (e.g., polymers) via MLD, or hybrid organic-inorganic via A-MLD.

Compared to bare Li∥NMC811 LMBs, the embodiments of the present invention have improved cyclability and safety. Thus, the embodiments of the present invention provide for commercially stable Li∥NMC811 LMBs.

In one embodiment, the present invention comprises NMC811 electrode fabrication, MLD organic coatings (LiGL, GL=glycerol; LiEG, EG=ethylene glycol, and LiHQ, HQ=hydroquinone and LiTEA, TEA=triethanolamine), ALD inorganic coatings (metal sulfides (MS), LiₓM_{y}S, and LiₓM_{y}O, M=Al, Zr, Ga, and Zn), A-MLD hybrid coatings which combine one of the ALD coatings and one of the MLD coatings, and electrochemical evaluation of Li∥NMC811 LMB cells.

### Electrode Preparation

Exemplary NMC811 electrode laminates may contain 86 wt. % NMC811 powder (MSE Supplies), 7 wt. % polyvinylidene fluoride (PVDF, HSV900, MTI Corporation), 7 wt. % carbon black (Timical super C65). To fabricate the laminates, a slurry was first prepared by mixing NMC811 powders, PVDF, and carbon black with a suitable amount of 1-Methyl-2-pyrrolidinone (NMP, 99.5%, Sigma-Aldrich) homogenously. Then, the slurry was coated on Al foils. The resultant NMC laminates were fully dried in air first and then in vacuum at 100 C for 10 hrs. The mass loading of the prepared NMC811 is ˜7.0 mg cm-2.

### ALD Coatings

Binary metal sulfide (MS) coatings. The metal sulfides include Li₂S, ZnS, Al₂S₃, Ga₂S₃, and ZrS₂. In this invention, these metal sulfides were coated on NMC electrodes or NMC powders via their ALD processes. For instance, the Li₂S coating was deposited on NMC811 laminates at 150° C. using an ALD system (Savannah 200, Cambridge Nanotech Inc., USA) integrated with an Ar-filled glove box. This integrated ALD-glove box facility guaranteed no air-exposure to the Li₂S-coated NMC811 laminates. The Li₂S ALD was proceeded using lithium tert-butoxide (LTB, 98 at. %, Strem Chemicals, Inc.) and hydrogen sulfide (H₂S, 4 at. % in Argon, Airgas) as precursors. Ar was used as the carrier gas of the ALD precursors. To provide sufficient vapor pressure, the solid LTB was heated to 150° C. in a stainless steel bubbler. The timing sequence of a single ALD Li₂S cycle was typically in a sequence of t1-t2-t3-t4, corresponding to the LTB dose, the first Ar purge, the H₂S dose, and the second Ar purge, respectively. NMC electrodes were coated with different ALD cycles for different coating thicknesses. The growth per cycle of the ALD Li₂S was ˜1.1 Å/cycle.

Similarly, the other MS coatings were deposited as follows. The ALD ZnS coatings were deposited using diethylzinc (DEZ, C₂H₅) and H₂S as precursors. The ALD Al₂S₃ coatings were deposited using tris(dimethylamido)aluminum (TDMA-Al, Al₂(NMe₂)₆, where Me=CH₃) and H₂S as precursors. The ALD Ga₂S₃ coatings were deposited using hexakis(dimethylamido)digallium (Ga₂(NMe₂)₆, Me=CH₃) and H₂S as precursors. The ALD ZrS₂ coatings were deposited using tetrakis(dimethylamido)zirconinum (TDMA-Zr, Zr(NMe₂)₄, Me=CH₃) and H₂S as precursors.

Ternary LiₓM_{y}S (LMS) Coatings.

The LMS coatings were developed through combining the Li_{z}S ALD with one of the MS ALD processes (M=Al, Zn, Ga, and Zr). The ALD LiₓAl_{y}S used the precursor pair of LTB and H₂S for ALD Li—S and the precursor pair of TDMA-Al and H₂S for ALD Al—S. The ALD LiₓZn_{y}S used the precursor pair of LTB and H₂S for ALD Li—S and the precursor pair of DEZ and H₂S for ALD Zn—S. The ALD LiₓGa_{y}S used the precursor pair of LTB and H₂S for ALD Li—S and the precursor pair of Ga₂(NMe₂)₆ and H₂S for ALD Ga—S. The ALD LiₓZr_{y}S used the precursor pair of LTB and H₂S for ALD Li—S and the precursor pair of TDMA-Zr and H₂S for ALD Zr—S.

LiₓM_{y}O (LMO) Coatings.

The LMO coatings were developed through combining the LiOH ALD with one of the MO ALD (M=Al, Zn, Ga, and Zr). The ALD LiₓAl_{y}O used the precursor pair of LTB and H₂O for ALD LiOH and the precursor pair of TDMA-Al and H₂O for ALD Al—O. The ALD LiₓZn_{y}O used the precursor pair of LTB and H₂O for ALD LiOH and the precursor pair of DEZ and H₂O for ALD Zn—O. The ALD LiₓGa_{y}O used the precursor pair of LTB and H₂O for ALD LiOH and the precursor pair of Ga₂(NMe₂)₆ and H₂O for ALD Ga—O. The ALD LiₓZr_{y}O used the precursor pair of LTB and H₂O for ALD LiOH and the precursor pair of TDMA-Zr and H₂O for ALD Zr—O.

### MLD Coatings:

Using a commercial MLD system (Savannah 200, Ultratech Inc., MA) with argon (Ar) as the carrier gas, three MLD processes of lithicones have been investigated in this study, i.e., LiGL, LiEG, LiHQ and LiTEA. LTB was preheated in a bubbler at 150° C. for a sufficient vapor supply, while EG, GL, HQ and TEA were maintained in stainless steel cylinders at 40, 150, 150, and 150° C., respectively. This MLD system was integrated with an Ar-filled glove box (having an oxygen and water concentration lower than 1 ppm) and this integration has greatly expanded the fabrication capability of the MLD system to many air-sensitive materials. In these three processes, LTB as the Li source was commonly used to couple with GL, EG, HQ and TEA to deposit LiGL, LiEG, LiHQ and LiTEA at 150° C., respectively. The timing sequence of a single MLD cycle was typically in a sequence of t₁-t₂-t₃-t₄, corresponding to the LTB dose, the first Ar purge, the GL/EG/HQ/TEA dose, and the second Ar purge, respectively.

### A-MLD Hybrid Coatings:

Combining one of the above-mentioned ALD processes and one of the above-described MLD processes, there were many different hybrid organic-inorganic coatings developed via the resultant A-MLD processes, such as MS-lithicone, LMS-lithicone, and LMO-lithicone.

### Electrochemical Measurements:

Li anodes and NMC811 cathodes were assembled into Li∥NMC811 coin cells in the Ar-filled glove box. In the glove box, oxygen and water were controlled at less than 0.01 ppm. Celgard 2325 membrane was used as the separator. There were two electrolytes that were used. One electrolyte was 1 M bis(trifluoromethane)sulfonamide lithium salt (LiTFSI) in 1,3-dioxolane (DOL) and 1,2-dimethoxyethane (DME) (1:1, v/v by volume). Another electrolyte was 1.2 M LiPF₆ in ethylene carbonate (EC)/ethyl methyl carbonate (EMC) (3:7 w/w by weight). Each cell contained 20 μl one of the two electrolytes. All the assembled cells were rested for 20 hours prior to their electrochemical tests at room temperature. Galvanostatic charge-discharge was carried out using a battery test system. The cells were cycled at different current rates (C-rates) via a constant current (CC) mode in the voltage ranges of 3.0-4.1 and 3.0-4.3 versus Li/Li⁺.

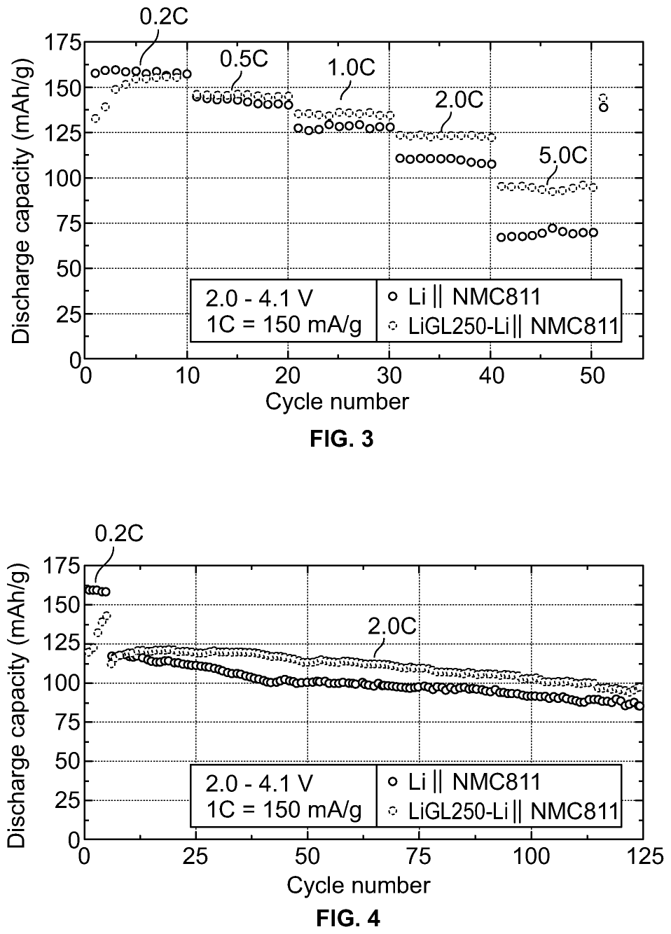

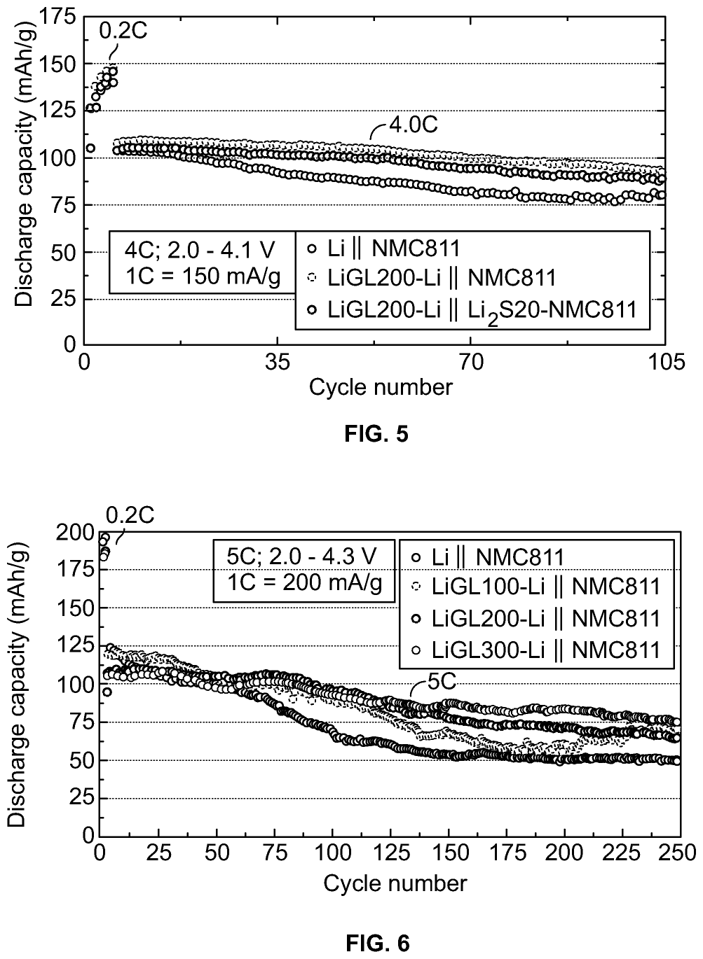

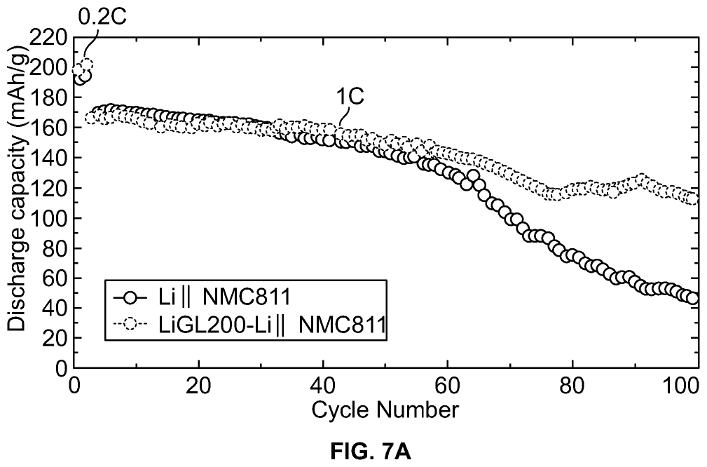

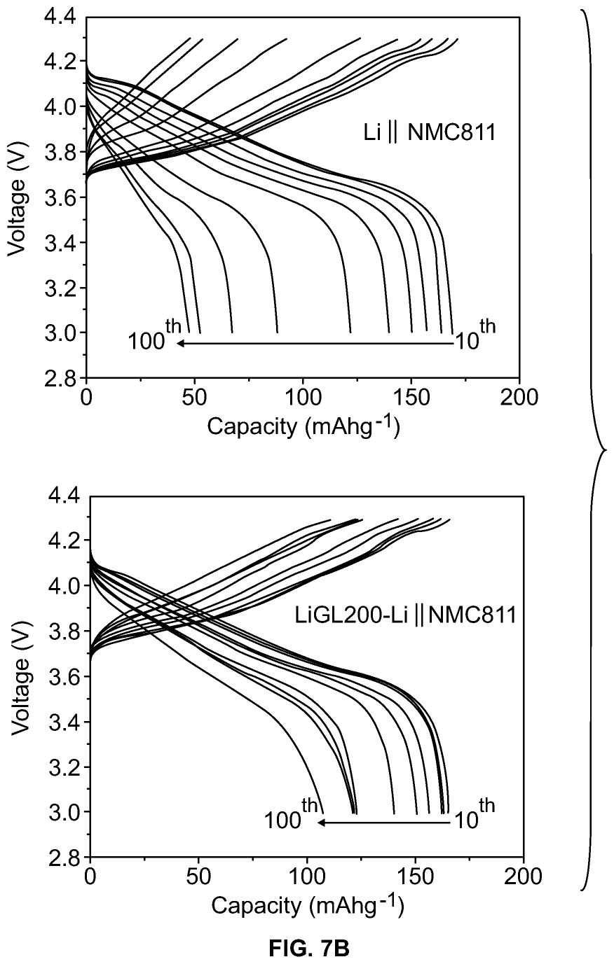

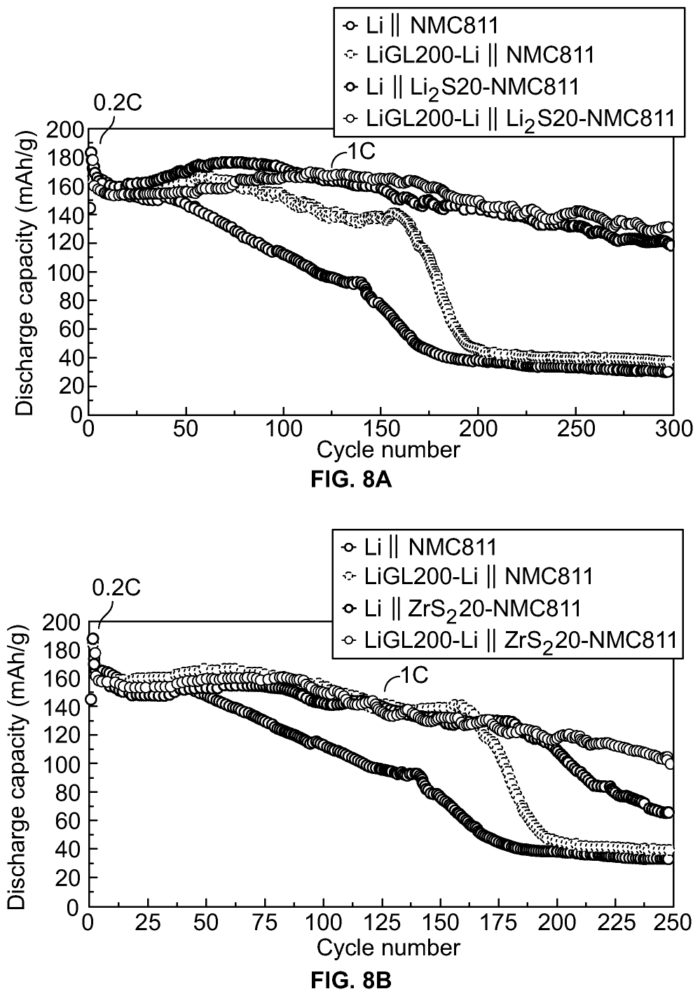

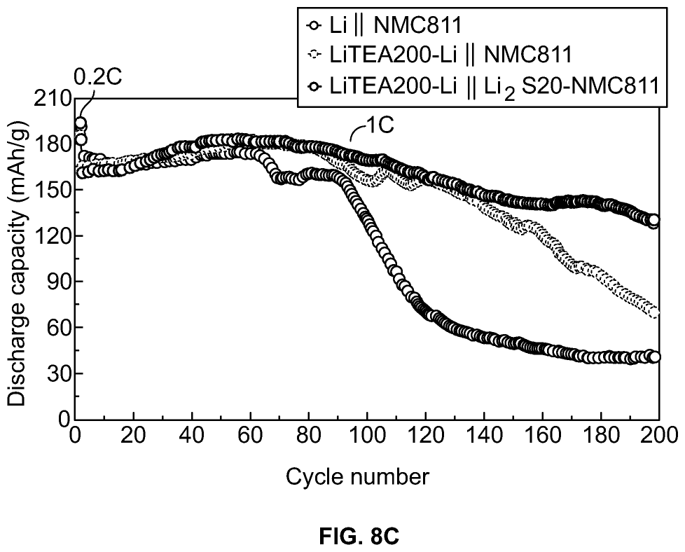

The effects of the MLD LiGL coatings on Li anodes were electrochemically investigated in Li∥NMC811 cells, as shown in FIG. 3, FIG. 4, FIG. 5, FIG. 6, FIG. 7, and FIG. 8.

As shown in FIG. 3, the rate capability of the Li∥NMC811 and LiGL250-Li∥NMC811 cells with an uncoated and LiGL250-coated Li anode, respectively, is comparatively investigated the voltage window of 2.0-4.1 V. Evidently, the LiGL250-Li∥NMC cell has much better sustainable capacities than those of the Li∥NMC811 cell, due to the protective effects of the LiGL250 MLD coating (i.e., 250 MLD cycles of LiGL). The LiGL250 coating inhibited SEI and Li dendrites from growth and thereby contributed to a higher capacity under different current rates.

FIG. 4 shows that, in the voltage window of 2.0-4.1, the LiGL250-Li∥NMC811 cell could sustain higher discharge capacity than that of the Li∥NMC811 cell in 120 charge-discharge cycles at 2 C after 5 charge-discharge cycles at 0.2 C.

FIG. 5 shows that, in the voltage window of 2.0-4.1, the LiGL200-Li∥NMC811 cell could sustain higher discharge capacity than that of the Li∥NMC811 cell in 100 charge-discharge cycles at 4 C after 5 charge-discharge cycles at 0.2 C.

In addition, FIG. 5 also shows that LiGL200-Li∥Li₂S20-NMC811 exhibited comparable discharge capacities as those of LiGL200-Li∥NMC811.

FIG. 6 revealed that, in the voltage window of 2.0-4.3, thicker LiGL coatings enabled higher discharge capacities at 5 C. After 250 charge-discharge cycles, for instance, the LiGL300-Li∥NMC811 sustained a capacity of 75 mAh/g, while the Li∥NMC811 cell had a capacity of 50 mAh/g. All these results confirm that the LiGL coatings on Li anodes helped sustain higher capacities of NMC811 cathodes. Particularly, the LiGL coatings helped LiGL-coated Li∥NMC cells to realize extremely fast charge/discharge up to 5 C.

FIG. 7 shows the cyclability of Li∥NMC811 and LiGL200-Li∥NMC811 at 1 C (1 C=200 mA/g) in the voltage range of 3.0-4.3 V, showing that (a, b) the LiGL coating of 200 MLD cycles is remarkably beneficial to improve sustainable capacity of LiGL200-Li∥NMC811 cell. The electrolyte is 1.2 M LiPF₆ in 3:7 EC/EMC (EC=ethylene carbonate and EMC=ethyl methyl carbonate).

FIG. 8 shows the effects of MLD coatings of LiGL and LiTEA and the ALD coatings of Li₂S and ZrS₂ on the performance of Li∥NMC811 cells, where the MLD coatings were deposited on Li anodes and the ALD coatings were deposited on NMC811 cathodes. (a) LiGL200-Li∥Li₂S20-NMC811 has the best performance while both LiGL200-Li∥NMC811 and Li∥Li₂S20-NMC811 cells performed better than Li∥NMC811. (b) LiGL200-Li∥ZrS220-NMC811 has the best performance while both LiGL200-Li∥NMC811 and Li∥ZrS220-NMC811 cells performed better than Li∥NMC811. (c) LiTEA200-Li∥Li₂S20-NMC811 has the best performance while the LiTEA200-Li∥NMC811 cell performed better than Li∥NMC811. All the cells tested first for 2 charge-discharge cycles at 0.2 C and then tested in the following cycles at 1 C (1 C=200 mA/g) in the voltage range of 3.0-4.3 V. the results show that the ALD and MLD coatings have remarkable benefits on Li∥NMC811 cells and the Li∥NMC811 could achieve the best performance with both an MLD-coated Li anode and an ALD-coated cathode. The electrolyte is 1.2 M LiPF6 in 3:7 EC/EMC.

To summarize, the MLD LiGL coatings have clearly demonstrated significant effects on improving the performance of LiGL-coated Li∥NMC811 cells up to 400%, in terms of sustainable capacity of NMC811 (see FIG. 3-8). The beneficial effects lie in multiple aspects including mitigation of SEI formation and inhibit Li dendrites from growth. The beneficial effects of the MLD LiGL coatings may also include mitigating the negative effects due to the dissolved transition metal ions of NMC811, facilitating the transport of Li ions, and reducing the consumption of the electrolyte.

Using the electrolyte of 1.2 M LiPF₆ in 3:7 EC/EMC

Li∥NMC811 cells were further tested in the electrolyte of 1.2 M LiPF₆ in 3:7 EC/EMC in the voltage range of 3-4.3 V. As shown in FIG. 7 and FIG. 8, all these cell were first tested for 2 charge-discharge cycles and then tested under 1 C for the rest of the cycles. In these cells, the effects of the MLD coatings of LiGL and LiTEA and the ALD coatings of Li₂S and ZrS₂ are investigated with different combinations. It was shown that the cells with an MLD-coated Li anode and an ALD-coated cathode could realize the best performance, compared to the cells with a coating on either an anode or a cathode and the control cell without any coating. All these results indicate that surface coatings via ALD and MLD on the Li anode and the NMC811 cathode are very beneficial and it is promising to coat both the Li anode and NMC811 cathode for the best performance.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure. Also, to the above description, the materials attached hereto form part of the disclosure of this provisional patent application.

What is claimed is:

1. A battery comprising: an anode and cathode; said anode is a Li metal and said cathode is a Ni—Mn—Co composition (NMC); and said anode and cathode have an inorganic surface coating thereon.

2. The battery of claim 1 wherein said surface coating is an oxide.

3. The battery of claim 1 wherein said surface coating is a sulfide.

4. The battery of claim 1 wherein said surface coating is an oxide and said cathode is comprised of LiNi_{0.8}Mn_{0.1}Co_{0.1}O₂ (NMC811).

5. The battery of claim 1 wherein said surface coating is sulfide and said cathode is comprised of LiNi_{0.8}Mn_{0.1}Co_{0.1}O₂ (NMC811).

6. A battery comprising: an anode and cathode; said anode is a Li metal and said cathode is a Ni—Mn—Co composition (NMC); and said anode and cathode have an inorganic surface coating thereon.

7. The battery of claim 6 wherein said surface coating is a polymer and said cathode is comprised of LiNi_{0.8}Mn_{0.1}Co_{0.1}O₂ (NMC811).

8. A battery comprising: an anode and cathode; said anode is a Li metal and said cathode is a Ni—Mn—Co composition (NMC); and said anode and cathode have an organic and inorganic surface coating thereon.

9. The battery of claim 8 wherein said cathode is comprised of LiNi_{0.8}Mn_{0.1}Co_{0.1}O₂ (NMC811).

10. A method of making a battery comprising the steps of:
providing an anode and cathode; said anode is a Li metal and said cathode is a Ni—Mn—Co composition (NMC); and said anode and cathode having a surface coating thereon.

11. The method of claim 10 wherein said surface coating is an organic composition formed by MLD.

12. The method of claim 10 wherein said surface coating is a polymer composition formed by MLD.

13. The method of claim 10 wherein said surface coating is an inorganic composition formed by ALD.

14. The method of claim 10 wherein said surface coating is an oxide formed by ALD.

15. The method of claim 10 wherein said surface coating is a sulfide formed by ALD.

16. The method of claim 10 wherein said surface coating is an inorganic composition formed by ALD and an organic composition formed by MLD.

17. The method of claim 11 wherein said cathode is comprised of LiNi_{0.8}Mn_{0.1}Co_{0.1}O₂ (NMC811).

18. The method of claim 17 wherein said battery has a charge and discharge of up to 5 C, where 1 C means one charge or discharge (charge/discharge) in one hour while 5 C means one charge/discharge in ⅕ hours (12 min per charge/discharge).

19. The method of claim 13 wherein said cathode is comprised of LiNi_{0.8}Mn_{0.1}Co_{0.1}O₂ (NMC811).

20. The method of claim 19 wherein said battery has a charge and discharge of up to 5 C, where 1 C means one charge or discharge (charge/discharge) in one hour while 5 C means one charge/discharge in ⅕ hours (12 min per charge/discharge).

21. The method of claim 18 wherein said surface-modified Li anodes and NMC811 cathodes have improved mitigation of SEI formation and inhibition of Li dendrites from growth.

22. The method of claim 18 wherein said surface-modified Li anodes and NMC811 cathodes mitigate the negative effects due to the dissolved transition metal ions of NMC811, facilitating the transport of Li ions, and reducing the consumption of the electrolyte.

23. The method of claim 20 wherein said surface-modified Li anodes and NMC811 cathodes have improved mitigation of SEI formation and inhibition of Li dendrites from growth.

24. The method of claim 20 wherein said surface-modified Li anodes and NMC811 cathodes mitigate the negative effects due to the dissolved transition metal ions of NMC811, facilitating the transport of Li ions, and reducing the consumption of the electrolyte.
